(19) United States
(12) Patent Application Publication
(10) Pub. No.: US 2011/0036657 A1
(43) Pub. Date: Feb. 17, 2011

(54) ELECTRIC VEHICLE CHASSIS

(75) Inventors: Aaron Bland, Ashland, OR (US); Sam Smith, Ashland, OR (US); Paul Daniel, Ashland, OR (US); Wayne Buck, Medford, OR (US)

Correspondence Address: FOLEY HOAG, LLP;PATENT GROUP, WORLD TRADE CENTER WEST, 155 SEAPORT BLVD, BOSTON, MA, 02110, US

(73) Assignee: Brammo, Inc., Ashland, OR (US)

(21) Appl. No.: 12/540,646

(22) Filed: Aug. 13, 2009

(51) Int. Cl. B62K 11/04; B62D 21/00; B23P 11/00

(52) U.S. Cl. 180/220; 180/312; 29/428

(57) ABSTRACT

A chassis for an electric vehicle includes a frame structure comprising two beam members arranged side-by-side with a gap therebetween. Each of the beam members includes a front end connected to the front end of the other beam member and forms a head tube for pivotally retaining a portion of a fork assembly holding a front wheel of the electric vehicle. Each of the beam members includes a rear end fixedly connected to a motor housing. The gap between the beam members is configured for holding one or more battery modules therein. The chassis also includes a swing arm assembly including a front end connected at a pivot point to the motor housing. The swing arm assembly includes a rear end holding a rear wheel of the electric vehicle.

### BACKGROUND

The present application relates generally to electric vehicles and, more particularly, to a chassis for electric vehicles.

### BRIEF SUMMARY OF EMBODIMENTS OF THE INVENTION

In accordance with one or more embodiments, a chassis for an electric vehicle is provided. The chassis includes a frame structure comprising two beam members arranged side-by-side with a gap therebetween. Each of the beam members includes a front end connected to the front end of the other beam member and forms a head tube for pivotally retaining a portion of a fork assembly holding a front wheel of the electric vehicle. Each of the beam members includes a rear end fixedly connected to a motor housing. The gap between the beam members is configured for holding one or more battery modules therein. The chassis also includes a swing arm assembly including a front end connected at a pivot point to the motor housing. The swing arm assembly includes a rear end holding a rear wheel of the electric vehicle.

In accordance with one or more embodiments, a method of securing one or more battery modules in an electric vehicle is provided. The method includes providing a chassis for the electric vehicle. The chassis comprises: (i) a fork assembly holding a front wheel of the electric vehicle; (ii) a motor housing for enclosing a motor; (iii) a frame structure comprising two beam members arranged side-by-side with a gap therebetween, each of the beam members including a front end connected to the front end of the other beam member and forming a head tube for pivotally retaining a portion of the fork assembly, each of the beam members including a rear end fixedly connected to the motor housing; and (iv) a swing arm assembly including a front end connected at a pivot point to the motor housing, the swing arm assembly including a rear end holding a rear wheel of the electric vehicle. The method includes placing one or more battery modules in the gap between the beam members, and securing the battery modules to the beam members.

In accordance with one or more embodiments, an electric vehicle is provided. The electric vehicle includes a front wheel, a rear wheel, a motor for driving one or both of the front and rear wheels, a throttle control apparatus for controlling operation of the motor, and a steering assembly for turning the front wheel to steer the electric vehicle. The electric vehicle also includes a chassis for distributing loads between the front and rear wheels. The chassis includes a fork assembly holding a front wheel of the electric vehicle, a motor housing for enclosing a motor, a frame structure, and a swing arm assembly including a front end connected at a pivot point to the motor housing. The swing arm assembly includes a rear end having an axle holding mechanism for holding the rear wheel of the electric vehicle. The frame structure comprises two beam members arranged side-by-side with a gap therebetween. Each of the beam members includes a front end connected to the front end of the other beam member and forms a head tube for pivotally retaining a portion of the fork assembly. Each of the beam members includes a rear end fixedly connected to the motor housing. The gap between the beam members is configured for holding one or more battery modules therein.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a side view of an exemplary electric vehicle incorporating a chassis in accordance with one or more embodiments of the invention.

FIG. 2 is a schematic side view of the electric vehicle with certain parts removed to illustrate the chassis in accordance with one or more embodiments of the invention.

FIG. 3 is an exploded view of the frame structure in accordance with one or more embodiments of the invention.

FIG. 4 is an exploded front view of an alternate frame structure with heat sink fins in accordance with one or more embodiments of the invention.

### DETAILED DESCRIPTION

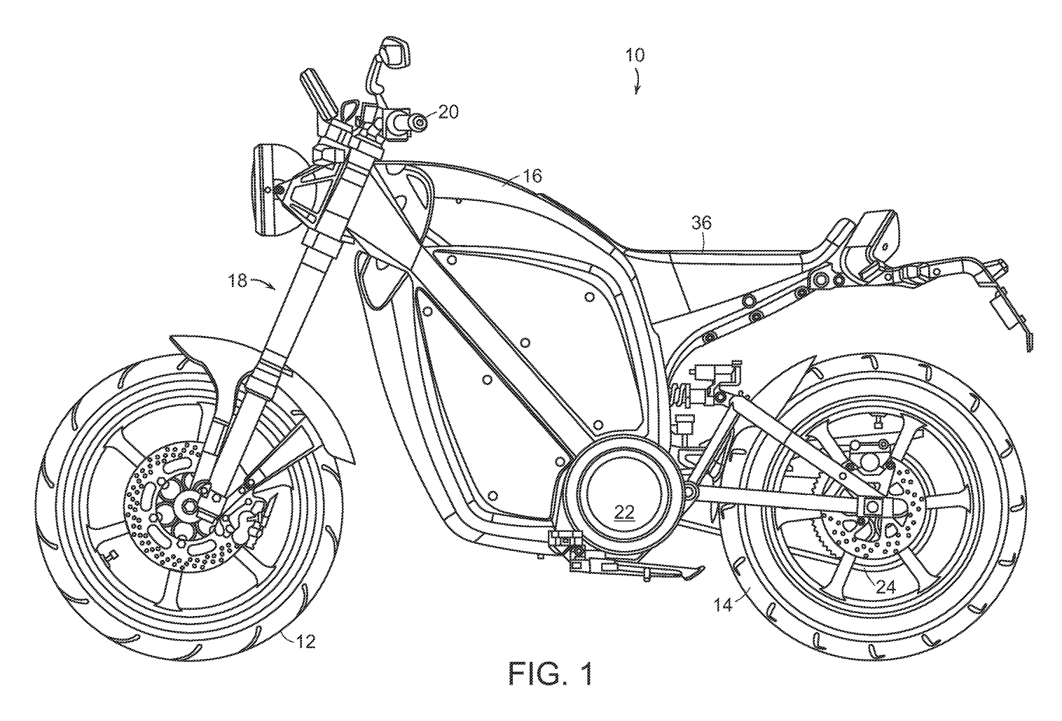

FIG. 1 illustrates an example of an electric vehicle 10 (in this case an electric motorcycle) in accordance with one or more embodiments of the invention. The electric vehicle includes a front wheel 12, a rear wheel 14, and a chassis 16 interconnecting the front and rear wheels 12, 14. The chassis 16 distributes the weight of the electric vehicle and rider between the front and rear wheels12, 14.

The electric vehicle 10 includes a front wheel steering assembly 18, which is pivotable about a steering axis and includes a handlebar 20 for imparting pivotal motion to the steering assembly 18. The handlebar 20 includes a left-side grip and a right-side grip (the throttle grip) that can be grasped by a rider to control the electric vehicle 10. The throttle grip controls operation of a motor 22, which drives the rear wheel 14 using a chain drive mechanism 24.

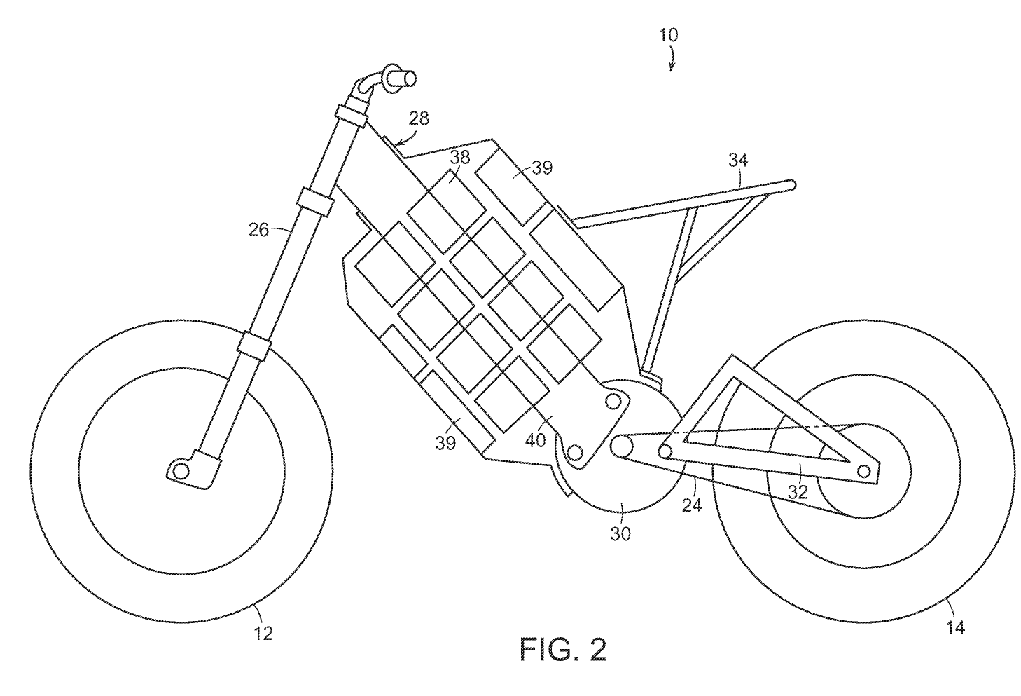

FIG. 2 schematically depicts the electric vehicle 10 with portions removed to further illustrate a chassis 16 in accordance with one or more embodiments. The chassis 16 includes a fork assembly 26 (which holds the front wheel 12), a frame structure 28, a motor housing 30 (which encloses the electric motor 22 or a motor/generator unit), and a swing arm assembly 32 (which forms a rear suspension system and holds the rear wheel 14). In addition, the chassis 16 includes a subframe structure 34 attached to the frame structure 28. The subframe structure 34 supports a seat mounting unit, which holds a seat 36 for the rider.

The frame structure 28 is configured to hold one or more battery modules 38 and/or other components 39 of the electric vehicle, as will be further described below.

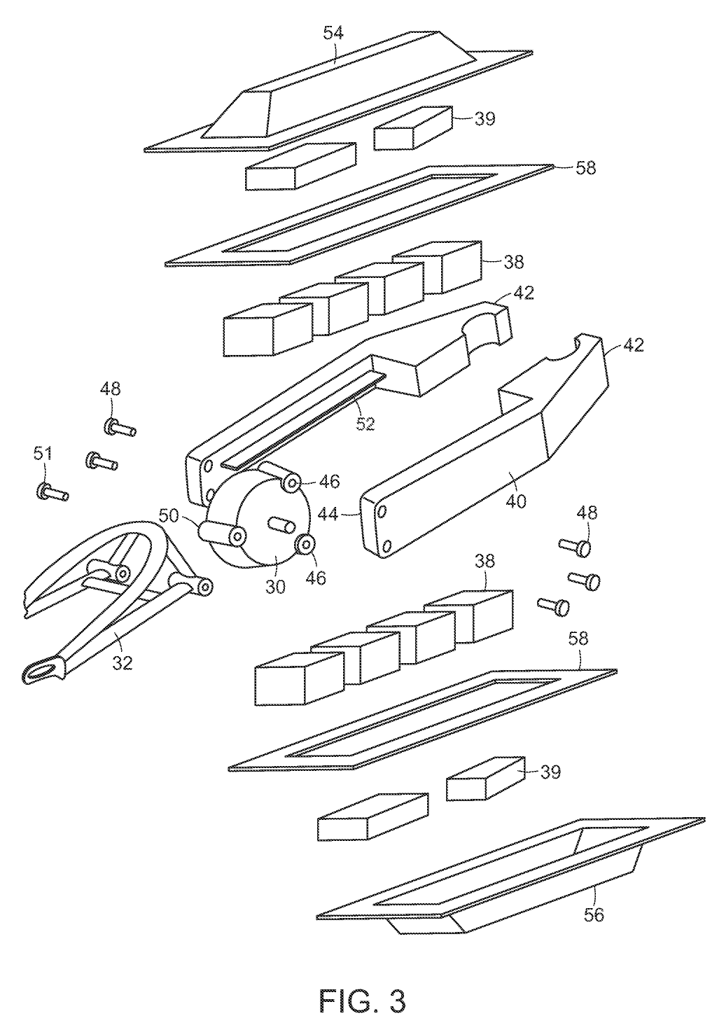

FIG. 3 is an exploded perspective view of the frame structure 28. The frame structure 28 includes two beam members 40 arranged side-by-side with a gap therebetween. Each of the beam members 40 includes a front end 42 connected to the front end of the other beam member 40. The front ends 42 of the beam members form a head tube for pivotally retaining a portion of the fork assembly 26, as part of the front wheel steering assembly 18.

Each of the beam members 40 includes a rear end 44 fixedly connected to the motor housing 30. In the exemplary embodiment, each of the beam members 40 is secured to the motor housing 30 at two connection points 46 using fasteners 48 such as bolts.

The motor housing 30 is pivotally attached to the swing arm assembly 32 at a pivot point 50 using a bolt or other fastener 51. The motor housing 30 thereby serves as a pivot for the rear suspension, and transfers loads between the frame structure 28 and the rear suspension.

The beam members 40 of the frame structure 28 each includes a lip member 52 extending inwardly into the gap between the beam members 40. As will be described below, the lip member 52 engages and supports the battery modules 38 held by the frame structure 28.

The beam members 40 are preferably made by casting, forging, or extruding, and may be welded together at their front ends 42. Although various materials can be used, the beam members 40 preferably comprise aluminum, e.g., 6061-T6 aluminum, A356-T6 aluminum, and A380 aluminum.

The frame structure 28 also includes upper and lower cover elements 54, 56 attached to the beam members by bolts or other fasteners to substantially cover the gap between the beam members 40 and define a generally sealed enclosure for holding the battery modules 38 and other components 39 therein. The cover elements 54, 56 can be removed to permit the battery modules 38 and other components 39 stored in the enclosure to be removed and replaced for servicing as needed.

The cover elements 54, 56 can be made by casting or formed from a sheet metal. Although various materials can be used, the cover elements 54, 56 preferably comprise aluminum, e.g., A356-T6 aluminum and A380 aluminum.

The cover elements 54, 56 are optional and not provided in some embodiments.

As shown in FIGS. 2 and 3, the frame structure 28 is configured to hold a plurality of battery modules 38 and other electric vehicle components 39. As depicted in the figures, the exemplary frame structure 28 holds a set of four battery modules 38 on an upper side of the frame structure 28 and a set of four battery modules 38 on the lower side of the frame structure 28. Each set of battery modules 38 is held against the lip members 52 of the beam members 40. The battery modules 38 are securely held in place in the frame structure 28 using mounting brackets, straps, or other attachment devices.

In addition to the battery modules 38, the frame structure 28 can support various other electric vehicle components 39 such as a motor controller, a battery charger, a battery management system, a voltage converter, a vehicle control unit, and a wiring harness. In the exemplary embodiment, these vehicle components 39 are mounted on the inside of the upper and lower cover elements 54, 56. The components 39 can be secured to the cover elements 54, 56 using mounting brackets, straps, or other attachment devices.

The cover elements 54, 56 are preferably sealingly attached to the beam members 40 in order to provide environmental protection (e.g., from moisture, matter, and electromagnetic interference) to the battery modules 38 and other components 39 stored therein. A gasket 58 is provided between each cover elements 54, 56 and the beam members 40 to provide a generally sealed connection. The frame structure 28 thereby seals and encloses the battery modules 38 and other components 39 stored therein. By using a sealed enclosure, the battery modules 38 and vehicle components 39 need not be individually sealed for environmental protection, thereby reducing the overall volume and weight of the electric vehicle.

Additionally, the battery modules 38 and the components 39 are arranged in close proximity in the frame structure 28, which allows simplified and shorter wiring to be used.

The frame structure 28 is configured to efficiently dissipate heat from the battery modules 38 and other components 39 stored therein to the surrounding air. The battery modules 38 and other components 39 have a thermal connection to the frame structure 28, which provides a large surface area for heat dissipation.

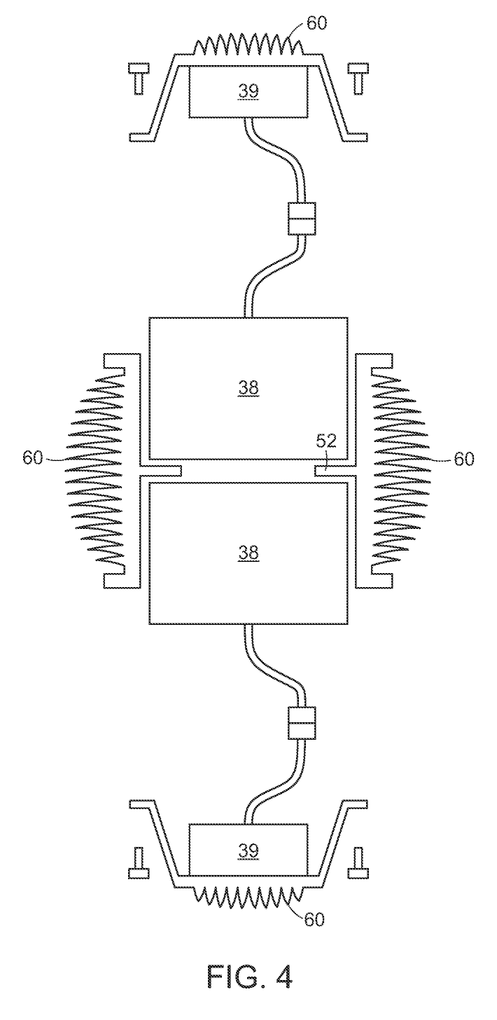

In one or more alternate embodiments as illustrated in FIG. 4, the frame structure 28 includes heat sink fins 60 to further enhance heat dissipation. In the FIG. 4 embodiment, the battery modules 38 maintain a thermal connection with the beam members 40, and the components 39 maintain a thermal connection with the upper and lower cover elements 54, 56. Thermal paste may optionally be used to improve the thermal connection. The beam members 40 and cover elements 54, 56 each include a set of heat sink fins 60 through which heat can be effectively dissipated.

The electric vehicle is preferably configured to provide an air flow path across the outer surfaces of the frame structure 28 to increase dissipation of heat. The airflow can be provided by a motorized fan or a vent.

Use of the frame structure 28 to hold battery modules 38 and other electric vehicle components 39 provides a number of advantages. First, the frame structure 28 more efficiently utilizes space in the electric vehicle, providing greater storage space for battery modules 38 and other components 39. In addition, the frame structure 28 reduces the overall vehicle weight, allowing an increase in vehicle performance. In addition, implementing the frame structure 28 in the chassis improves chassis stiffness and vehicle handling. Also, the frame structure 28 provides improved environmental protection for powertrain components 39 from moisture, matter, and electromagnetic interference. Furthermore, the frame structure 28 improves thermal characteristics, by allowing heat from batteries and powertrain components 39 to be more quickly dissipated. The frame structure 28 also allows use of simplified wiring harnesses and connections. In addition, the frame structure 28 reduces cost of the electric vehicle and improves ease of manufacturing and assembly. The frame structure 28 also reduces the cost and ease of service on battery modules 38 and other components 39 stored therein.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A chassis for an electric vehicle, comprising:
a fork assembly holding a front wheel of the electric vehicle;
a motor housing for enclosing a motor;
a frame structure comprising two beam members arranged side-by-side with a gap therebetween, each of the beam members including a front end connected to the front end of the other beam member and forming a head tube for pivotally retaining a portion of the fork assembly, each of the beam members including a rear end fixedly connected to the motor housing, wherein the gap is configured for holding one or more battery modules therein; and
a swing arm assembly including a front end connected at a pivot point to the motor housing, the swing arm assembly including a rear end with an axle holding mechanism for holding a rear wheel of the electric vehicle.

2. The chassis of claim 1 further comprising one or more cover elements removably secured to the beam members to substantially cover the gap and define a generally sealed enclosure in the frame structure for holding the one or more battery modules therein.

3. The chassis of claim 2 wherein the frame structure is also configured to hold other components, each of the components being secured to the one or more cover elements.

4. The chassis of claim 3 wherein the other components comprise a motor controller, a battery charger, a battery management system, a voltage converter, a vehicle control unit, or a wiring harness.

5. The chassis of claim 2 wherein the one or more cover elements includes an access area for accessing components stored in the frame structure.

6. The chassis of claim 2 wherein the one or more cover elements comprise aluminum.

7. The chassis of claim 2 wherein the beam members and the cover elements include fins for increasing the rate of heat transfer from the battery modules or other components stored in the frame structure.

8. The chassis of claim 2 wherein the one or more cover elements are sealingly attached to the beam members.

9. The chassis of claim 1 wherein the beam members comprise aluminum.

10. The chassis of claim 1 wherein each of the beam members includes a lip extending into the enclosure for supporting the one or more battery modules.

11. The chassis of claim 1 further comprising two outer plates, each positioned on opposite sides of the motor housing for reducing stress on bolts connecting the frame structure to the motor housing and the swing arm assembly to the motor housing.

12. The chassis of claim 1 wherein the electric vehicle is an electric motorcycle.

13. The chassis of claim 1 further comprising a subframe structure fixedly connected to the frame structure for supporting a seat mounting structure.

14. A method of securing one or more battery modules in an electric vehicle, comprising the steps of:
(a) providing a chassis for the electric vehicle, the chassis comprising:
(i) a fork assembly holding a front wheel of the electric vehicle;
(ii) a motor housing for enclosing a motor;
(iii) a frame structure comprising two beam members arranged side-by-side with a gap therebetween, each of the beam members including a front end connected to the front end of the other beam member and forming a head tube for pivotally retaining a portion of the fork assembly, each of the beam members including a rear end fixedly connected to the motor housing; and
(iv) a swing arm assembly including a front end connected at a pivot point to the motor housing, the swing arm assembly including a rear end with an axle holding mechanism for holding a rear wheel of the electric vehicle;
(b) placing one or more battery modules in the gap between the beam members, and securing the battery modules to the beam members.

15. The method of claim 14 further comprising securing one or more cover elements to the beam members to substantially cover the gap and define a generally sealed enclosure in the frame structure for holding the one or more battery modules therein.

16. The method of claim 15 further comprising the step of positioning one or more other components in the generally sealed enclosure.

17. The method of claim 16 wherein the one or more other components comprise a motor controller, a battery charger, a battery management system, a voltage converter, a vehicle control unit, or a wiring harness.

18. The method of claim 16 further comprising securing the one or more other components to the one or more cover elements.

19. The method of claim 14 wherein each of the beam members includes a lip extending into the enclosure, and wherein step (b) comprises engaging the one or more battery modules with the lip.

20. The method of claim 14 wherein the chassis further comprises a subframe structure fixedly connected to the frame structure for supporting a seat mounting structure.

21. An electric vehicle, comprising:
a front wheel;
a rear wheel;
a motor for driving one or both of the front and rear wheels;
a throttle control apparatus for controlling operation of the motor;
a steering assembly for turning the front wheel to steer the electric vehicle; and
a chassis for distributing loads between the front and rear wheels, the chassis comprising:
a fork assembly holding a front wheel of the electric vehicle;
a motor housing for enclosing a motor;
a frame structure comprising two beam members arranged side-by-side with a gap therebetween, each of the beam members including a front end connected to the front end of the other beam member and forming a head tube for pivotally retaining a portion of the fork assembly, each of the beam members including a rear end fixedly connected to the motor housing, wherein the gap is configured for holding one or more battery modules therein; and
a swing arm assembly including a front end connected at a pivot point to the motor housing, the swing arm assembly including a rear end with an axle holding mechanism for holding a rear wheel of the electric vehicle.

22. The electric vehicle of claim 21 further comprising one or more cover elements removably secured to the beam members to substantially cover the gap and define a generally sealed enclosure in the frame structure for holding the one or more battery modules therein.

23. The electric vehicle of claim 22 wherein the frame structure is also configured to hold other components, each of the components being secured to the one or more cover elements.

24. The electric vehicle of claim 23 wherein the other components comprise a motor controller, a battery charger, a battery management system, a voltage converter, a vehicle control unit, or a wiring harness.

25. The electric vehicle of claim 22 wherein the one or more cover elements includes an access area for accessing components stored in the frame structure.

26. The electric vehicle of claim 22 wherein the one or more cover elements and the beam members comprise aluminum.

27. The electric vehicle of claim 22 wherein the beam members and the cover elements include fins for increasing the rate of heat transfer from the battery modules or other components stored in the frame structure.

28. The electric vehicle of claim 21 wherein each of the beam members includes a lip extending into the enclosure for supporting the one or more battery modules.

29. The electric vehicle of claim 21 wherein the electric vehicle is an electric motorcycle.

30. The electric vehicle of claim 21 wherein the chassis further comprises a subframe structure fixedly connected to the frame structure for supporting a seat mounting structure.
